(19) United States
(12) Patent Application Publication
(10) Pub. No.: US 2003/0016848 A1
(43) Pub. Date: Jan. 23, 2003

(54) Image reader

(76) Inventors: Hideki Kitajima, Chiba-shi (JP); Keiji Satou, Chiba (JP); Satoshi Machida, Chiba (JP)

Correspondence Address: Adams & Wilks, 31st Floor, 50 Broadway, New York, NY, 10004, US

(21) Appl. No.: 09/980,733

(22) PCT Filed: Mar. 8, 2001
(86) PCT No.: PCT/JP01/01810

(30) Foreign Application Priority Data
Mar. 8, 2000 (JP) 2000-63744

(51) Int. Cl. G06K 9/00

(52) U.S. Cl. 382/124

(57) ABSTRACT

An image reading apparatus includes a casing (1), an input member (2) having an input surface, a rotary member (3) formed of a transparent base material, a light source (4), a light detecting means (5) having a plurality of photoelectric conversion elements, and a signal processing means (8), wherein partial images obtained from light emitted from the light source toward the input surface and reflected by troughs of a finger (6) in contact with the input surface, and a light-dark pattern provided on the surface of one end portion of the rotary member adapted to rotate while in contact with the finger, are successively detected, whereby a whole image of a fingerprint is synthesized from the partial images by the signal processing means (8). Further, the light source and the light detecting means are arranged such that, in addition to the reflected light obtained from the input surface, scattered light is also detected, whereby it is also possible to read a planar image having light and shade like that of an original. Further, by outputting the rotating amount of the rotary member, it is also possible to effect a position input in accordance with the movement amount of the finger (6).

### TECHNICAL FIELD

The present invention relates to an image reading apparatus in which a synthesized whole image is obtained from partial images through detection of a relative moving amount of the object of reading and the image reading apparatus, whereby it is possible to read an object of reading having protrusions and recesses like a fingerprint and a planar object of reading having light and shade like an original.

### BACKGROUND ART

Examples of conventional image reading apparatuses are disclosed in Japanese Patent Application Laid-Open No. 11-353457 and Japanese Patent Application Laid-Open No. 9-240906, which are shown in FIGS. 18 and 19, respectively.

The image reading apparatus for reading fingerprints shown in FIG. 18 utilizes differences in reflected light due to the differences in state of contact between the crests and troughs of a fingerprint when the tip of a finger is applied to an optical member having a transparent input surface like a glass plate. That is, when a finger 1077 is applied to an input surface of a prism array 101 consisting of glass, synthetic resin or the like and serving as an input member, the crests of the skin are in contact with the input surface of the prism array, whereas the troughs of the skin are in contact with air. Thus, when the incidence angle becomes close to the critical angle at the interface between the prism array and the air, the reflectance becomes relatively high in the troughs, with the result that there is generated a large difference in reflectance between the crests and troughs, and the crests and troughs of the fingerprint are read as a light-dark pattern.

Further, an example of an image reading apparatus having a light detecting means and adapted to read fingerprints and originals by synthesizing a two-dimensional whole image from partial images through relative movement of the object of reading and the image reading apparatus is disclosed in Japanese Patent Application Laid-Open No. 10-240906, according to which illumination light is caused to impinge vertically upon the input surface to detect vertical reflected light.

In the image reading apparatus utilizing a prism array shown in FIG. 18, only a reflected light close to the critical angle is utilized, so that it is difficult to read an object which does not provide a complete optical contact as in the case of paper, for example, an original. Further, while a non-scanning type image reading apparatus can realize image processing relatively easily, it requires a large-area image taking means, such as a CCD, and involves a complicated optical system.

On the other hand, in the image reading apparatus shown in FIG. 19, a roller 201 and a rotary encoder (not shown) are used, and a whole image is synthesized from partial images of a fingerprint. This apparatus, which detects a relative moving distance of the fingerprint to reconstruct a fingerprint image, is advantageous in that the image processing is relatively easy and that it uses a linear image sensor 202 consisting of a CCD or the like and requiring a relatively small area. On the other hand, the use of a rotary encoder leads to high cost. In addition, in an image reading apparatus as shown in FIG. 19, which utilizes vertical incident and scattered light, the difference in scattered light between the crests and troughs of the finger is inferior to the difference in reflected light, so that when optically reading a fingerprint, it is necessary to secure more accumulation time for the light detecting means than when reading an original. Thus, while it is easy for the apparatus to read an original, its ability to read a fingerprint is rather low.

It is accordingly an object of the present invention to provide an image reading apparatus using a light detecting means and capable of reading an object of reading having protrusions and recesses like a fingerprint, and an image reading apparatus which is capable of accurately reading both an object of reading as mentioned above and a planar object of reading having light and shade like an original and which is of a simple structure.

### DISCLOSURE OF THE INVENTION

To achieve the above object, there is provided in accordance with claim 1 of the invention an image reading apparatus comprising a light source, an input member having an input surface for an object of reading, and a light detecting means composed of a plurality of photoelectric conversion elements for detecting light scattered or reflected at an interface between the object of reading and the input surface,

wherein the input member consists of a transparent base member and is formed by a rotary member rotating in accordance with an amount of relative movement between the object of reading and the image reading apparatus,

the apparatus further comprising a whole image synthesizing means which detects a rotating amount of a first rotary member by a first light detecting means to detect an amount of relative movement between the object of reading and the image reading apparatus and which obtains a whole image of the object of reading on the basis of a partial image obtained by the first light detecting means and the movement amount.

In accordance with claim 2 of the invention, there is provided an image reading apparatus according to claim 1, wherein a light-dark pattern is formed on a surface at one end of the first rotary member, and wherein the first light detecting means detects light emitted from a first light source and transmitted through the light-dark pattern to thereby detect a rotating amount of the first rotary member.

In accordance with claim 3 of the invention, there is provided an image reading apparatus according to claim 1 or 2, wherein the first light detecting means is at a position where it receives reflected light generated from the interface between the object of reading and the input surface and determined by Snell's law.

In accordance with claim 4 of the invention, there is provided an image reading apparatus according to claim 1 or 2, wherein the first light detecting means is at a position where it receives reflected light generated from the interface between the object of reading and the input surface and determined by Snell's law and scattered light generated from the interface between the input surface of the first rotary member and the object of reading.

In accordance with claim 5 of the invention, there is provided an image reading apparatus according to claims 1 through 4, wherein incident light emitted from the first light source and incident on the input surface has a plurality of different incidence angle components.

In accordance with claim 6 of the invention, there is provided an image reading apparatus according to one of claims 1 through 5, wherein there is provided one of an image formation optical system and a mirror between optical paths of the first rotary member and the first light detecting means.

In accordance with claim 7 of the invention, there is provided an image reading apparatus according to one of claims 1 through 5, wherein there is provided an optical fiber bundle between the optical paths of the first rotary member and the first light detecting means.

In accordance with claim 8 of the invention, there is provided an image reading apparatus according to one of claims 1 through 7, wherein the first rotary member and the image formation optical system are formed of a glass base material which is an inorganic base material or a synthetic resin which is an organic base material.

In accordance with claim 9 of the invention, there is provided an image reading apparatus according to one of claims 1 through 8, wherein there is provided on the input surface of the first rotary member a dirt prevention layer adapted to prevent dirt from adhering to the surface.

In accordance with claim 10 of the invention, there is provided an image reading apparatus according to one of claims 1 through 9, wherein there is provided a cleaner adapted to remove dirt adhering to the surface of the first rotary member.

In accordance with claim 11 of the invention, there is provided an image reading apparatus according to one of claims 1 through 10, wherein the object of reading includes an object of reading having protrusions and recesses like a fingerprint and an object of reading having light and shade like an original.

In accordance with claim 12 of the invention, there is provided an image reading apparatus according to one of claims 1 through 10, wherein there is provided a function by which a one-dimensional position input is effected in accordance with the rotating amount of the first rotary member.

In accordance with claim 13 of the invention, there is provided an image reading apparatus according to one of claims 1 through 10, further comprising a second rotary member having a rotation axis different from the rotation axis of the first rotary member and a means for detecting a rotating amount of the second rotary member, wherein there is provided a function by which a two-dimensional position input is effected in accordance with the rotating amount of the first rotary member and that of the second rotary member.

In accordance with claim 14 of the invention, there is provided an image reading apparatus according to one of claims 1 through 10, further comprising a second rotary member which has a rotation axis different from the rotation axis of the first rotary member and on the surface of one end portion of which a light-dark pattern is formed, a second light source, a second light detecting means, and a rotating amount detecting means for detecting a rotating amount of the second rotary member by detecting light emitted from the second light source and transmitted through the light-dark pattern formed on the surface of the second rotary member, wherein there is provided a function by which a two-dimensional position input is effected in accordance with the rotating amount of the first rotary member and that of the second rotary member.

### BRIEF DESCRIPTION OF THE DRAWINGS

FIG. 1 is a sectional view showing main components of an image reading apparatus according to an embodiment of the present invention;

FIG. 2 is a sectional view showing main components of an image reading apparatus according to an embodiment of the present invention;

FIG. 3 is a perspective view showing a rotary member and a light-dark pattern;

FIG. 4 is a sectional view illustrating the positional relationship between a light-dark pattern, incident light, and reflected light;

FIG. 5 is a diagram showing the relationship between a light-dark pattern and the output of a light detecting means;

FIG. 6 is a sectional view showing the incidence angle of incident light emitted from a light source and impinging upon an input surface;

FIG. 7 is a sectional view showing the relationship between refractive index and incidence-angle/reflectance characteristics;

FIG. 8 is a sectional view showing the relationship between incident light, reflected light, and scattered light;

FIG. 9 is a sectional view of an image reading apparatus according to an embodiment of the present invention which is capable of reading both a fingerprint and an original;

FIG. 10 is a sectional view of an image reading apparatus according to an embodiment of the present invention which is capable of reading both a fingerprint and an original;

FIG. 11 is a sectional view of an image reading apparatus according to an embodiment of the present invention which is capable of reading both a fingerprint and an original;

FIG. 12 is a sectional view showing an image reading apparatus according to an embodiment of the present invention;

FIG. 13 is a sectional view showing an image reading apparatus according to an embodiment of the present invention;

FIG. 14 is a sectional view showing an image reading apparatus according to an embodiment of the present invention;

FIG. 15 is a perspective view showing an image-reading/input apparatus according to an embodiment of the present invention;

FIG. 16 is a schematic diagram showing a mobile phone in which an image-reading/input apparatus according to an embodiment of the present invention is mounted;

FIG. 17 is a schematic diagram showing a mouse in which an image-reading/input apparatus according to an embodiment of the present invention is mounted;

FIG. 18 is a sectional view showing a conventional image reading apparatus; and

FIG. 19 is a sectional view showing a conventional image reading apparatus.

### BEST MODE FOR CARRYING OUT THE INVENTION

An image reading apparatus according to an embodiment of the present invention will now be described with reference to the drawings.

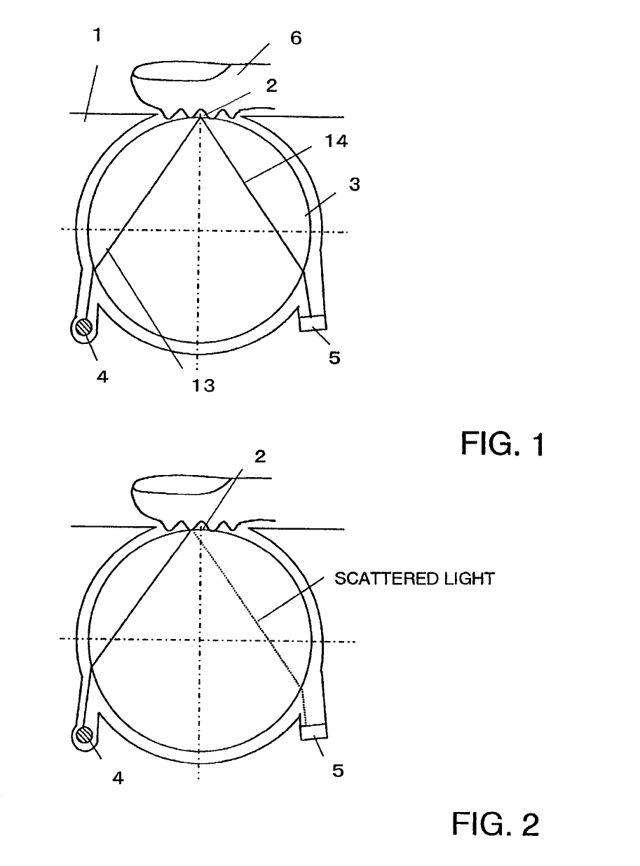

FIGS. 1 and 2 are sectional views showing main components of an image reading apparatus according to the present invention. This image reading apparatus comprises a casing 1, an input surface 2, a first rotary member 3 including the input surface and consisting of a transparent base material, a first light source 4 consisting of a cold-cathode tube, an LED, an EL or the like, and a first light detecting means 5 having a plurality of photoelectric conversion elements consisting of linear image sensors, such as CCDs.

The first rotary member 3 includes the input surface 2 and consists of a transparent base material, such as glass or synthetic resin. When reading a fingerprint, the tip of a finger 6 is brought into contact with the input surface 2. At this time, when light impinges upon a trough portion of the finger print as shown in FIG. 1, the light reflectance is high since the rotary member and the finger are then not in direct contact with each other. When light impinges upon a crest portion of the fingerprint as shown in FIG. 2, the light reflectance is low since the rotary member and the finger are then in direct contact with each other. As a result, it is possible to obtain an image of the portion of the fingerprint which is in contact with the input surface by the light detecting means. Next, when the finger is moved in the direction of the arrow to thereby rotate the rotary member that is in contact with the finger, it is possible to obtain a partial image of the fingerprint and, at the same time, the rotating amount of the rotary member by detecting light transmitted through a light-dark pattern formed on the surface of one end portion of the rotary member. Further, by repeatedly obtaining a partial image of the fingerprint and the rotating amount of the rotary member by the light detecting means, it is possible to synthesize a whole image of the finger print.

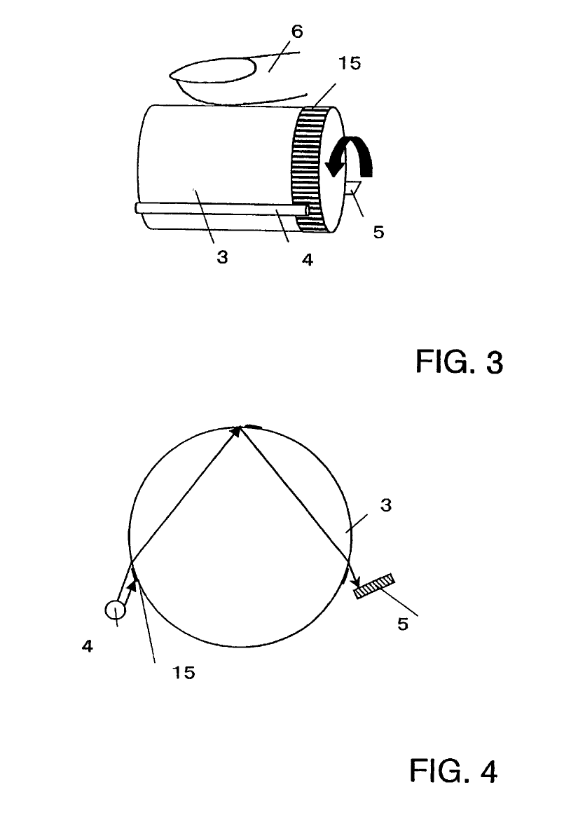

Next, the method of detecting the rotating amount of the rotary member by the light detecting means will be described in detail with reference to FIGS. 3 through 5.

FIG. 3 is a perspective view showing the positional relationship between the light source, the rotary member having a light-dark pattern 15 on the surface of one end portion thereof, and the light detecting means. FIG. 4 is a sectional view showing how light emitted from the light source is transmitted through the light-dark pattern. Light emitted from the light source impinges upon the rotary member and is transmitted through the light-dark pattern before it is reflected by the input surface and reaches the light-dark pattern again. From the positional relationship between the light-dark pattern, the incident light, and the reflected light, no light is transmitted through the dark portion of the light-dark pattern whereas light is transmitted through the light portion thereof. Thus, by detecting the transmitted light (refracted light) by the light detecting means, it is possible to detect the rotating amount of the rotary member.

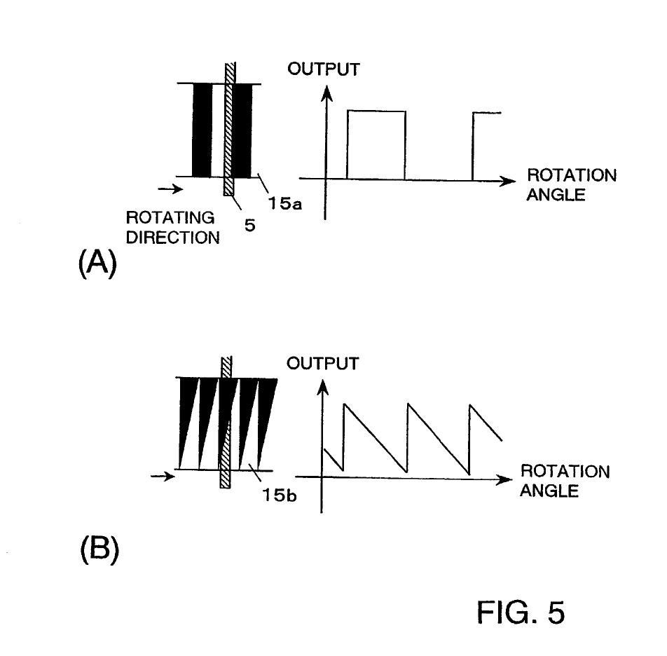

FIG. 5 shows the relationship between the light-dark pattern and the output of the light detecting means. In comparison with the strip-like light-dark pattern shown in FIG. 5A, the triangular light-dark pattern shown in FIG. 5B is more advantageous in that it allows the rotating direction to be detected easily and that it makes it possible to achieve higher resolution for the same cycle of the light-dark pattern. In this way, in the image reading apparatus of the present invention, a partial image is detected and, at the same time, the rotating amount of the rotary member is detected, so that even if the finger movement is not smooth, it is possible to synthesize a whole image relatively easily. While in the method of detecting the rotating amount of the rotary member shown in FIG. 3 a light-dark pattern is formed at one end of the rotary member and the rotating amount is detected through variation in the amount of light transmitted through the light-dark pattern, the method of detecting the rotating amount of the rotary member in the present invention is not restricted to this method. For example, it is also possible to use a separate rotary member adapted to rotate in synchronism with the rotary member that is into contact with the finger, detecting the rotating amount of the separate rotary member by the light detecting means.

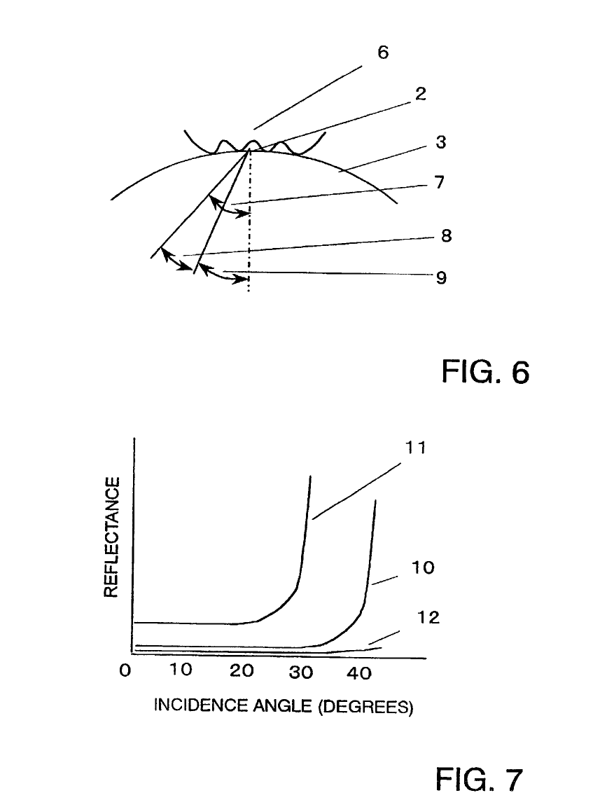

Next, the basic principle of reading a partial image of a fingerprint and an original by the image reading apparatus of the present invention will be described in detail with reference to FIGS. 6 through 8. In the present invention, the term “reflected light” means a reflected light which follows Snell's law at the interface of the input surface of the rotary member, and the term “scattered light” means a light which is transmitted through the input member and reflected by the finger skin or the original, or the interface of the air and the skin or the interface of the original and the air before returning to the input surface side of the rotary member.

FIG. 6 is a diagram showing the incidence angle of the incident light emitted from the light source and impinging upon the input surface.

The incident light emitted from the light source and impinging upon the input surface is within an incidence range 8 which is between a maximum incidence angle 7 and a minimum incidence angle 9 and has an illuminance of a value not lower than a fixed value.

Here, the maximum incidence angle is an angle smaller than the angle of total reflection of the reflected light with respect to the incident light from the rotary member to the input surface side, that is, the critical angle. The minimum incidence angle is 20 degrees.

That is, the position of the light source is set such that the incidence angle of the incident light from the light source to the input surface is not smaller than 20 degrees and smaller than the critical angle.

FIG. 7 shows the incidence-angle/reflectance characteristics when glass or synthetic resin is used for the rotary member. The refractive index of glass or synthetic resin, of which the rotary member is formed, is in the range of 1.5 to 2.

Reflectance curve 9 indicates the reflectance when the refractive index of the rotary member is 1.5, and reflectance curve 10 indicates the reflectance when the refractive index of the rotary member is 2, the rotary member being in contact with the air in each case. Reflectance curve 11 indicates the reflectance when the refractive index of the rotary member is 2, with the rotary member being in contact with the skin.

When the rotary member is in contact with the skin, there is substantially no change in reflectance up to the incidence angle of 40 degrees. Though not shown in the drawing, there is no change in reflectance, either, when the refractive index is 1.5. On the other hand, when the rotary member is in contact with the air, the critical angle is approximately 41.8 degrees when the refractive index is 1.5. As the refractive index increases, the critical angle is diminished. In particular, when the refractive index is 2, the critical angle is 30 degrees.

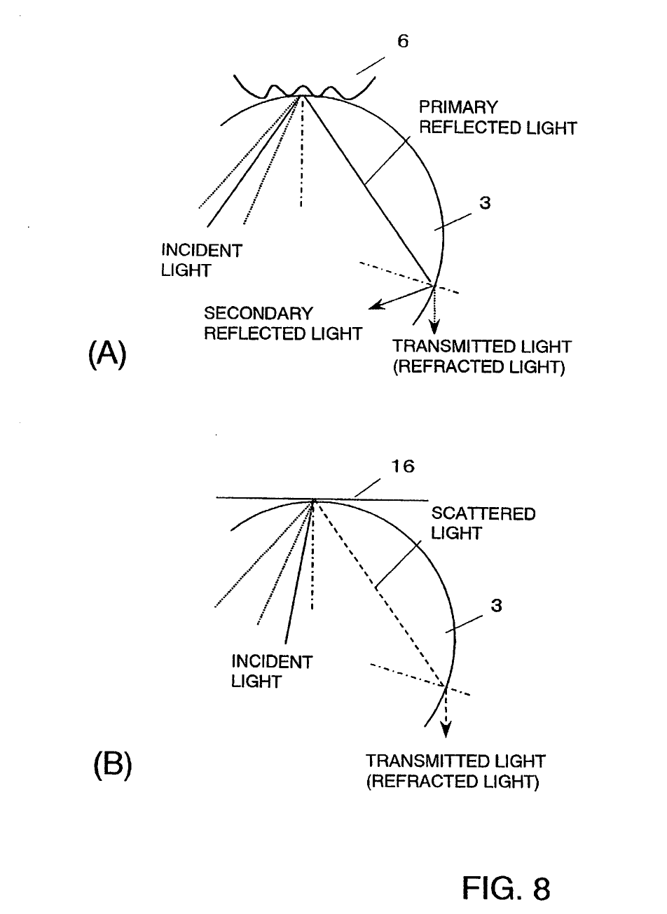

FIG. 8 is a diagram showing the condition of the incident light, reflected light, and scattered light when a fingerprint is read and when an original is read. FIG. 8A shows the incident light and reflected light when a fingerprint is read. In this way, when the incident light has an illuminance of a value not lower than a fixed value, with the incidence angle being not larger than the critical angle and not smaller than 20 degrees, the contrast at the input surface of the reflected light from the troughs and the crests of the fingerprint is higher than when light is incident and reflected vertically.

On the other hand, FIG. 8B shows the incident light and scattered light when an original is input. Due to multiple reflection, the scattered light is spread at a large angle. When the incident light from the light source is smaller than the critical angle, no total reflection occurs from the input surface side to the rotary member, so that detection is substantially possible at any position by the light detecting means.

By installing a plurality of light sources such that the incident light exhibits an illuminance of a value not lower than a fixed value within the range of not larger than 20 degrees and that the incident light exhibits an illuminance of a value not higher than the fixed value within the range of not smaller than 20 degrees, or by effecting divisional operation using a planar light source such as an EL as the light source, the reflected light is reduced, and reading is possible by the scattered light from the original or the like.

That is, when reading a fingerprint, reflected light is utilized, and, when reading an original, scattered light is utilized, whereby it is possible to read images of both a fingerprint and an original. Since the method of synthesizing a whole image from partial images is basically the same for a planar image having a pattern of light and shade as in the case of an original, the whole-image synthesizing method described above is applicable not only to fingerprints but also to originals.

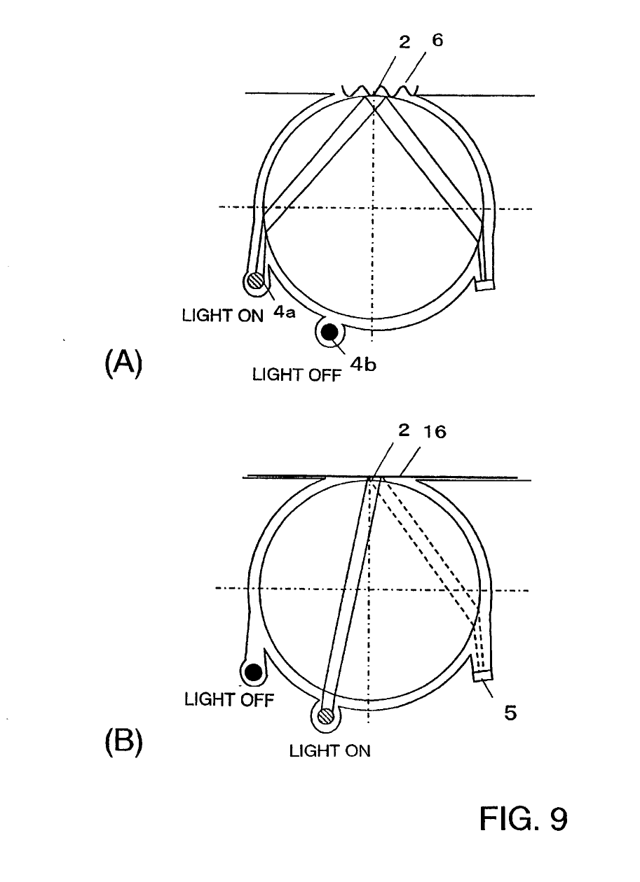

An embodiment of the image reading apparatus capable of reading fingerprints and originals will be described with reference to FIGS. 9 through 11.

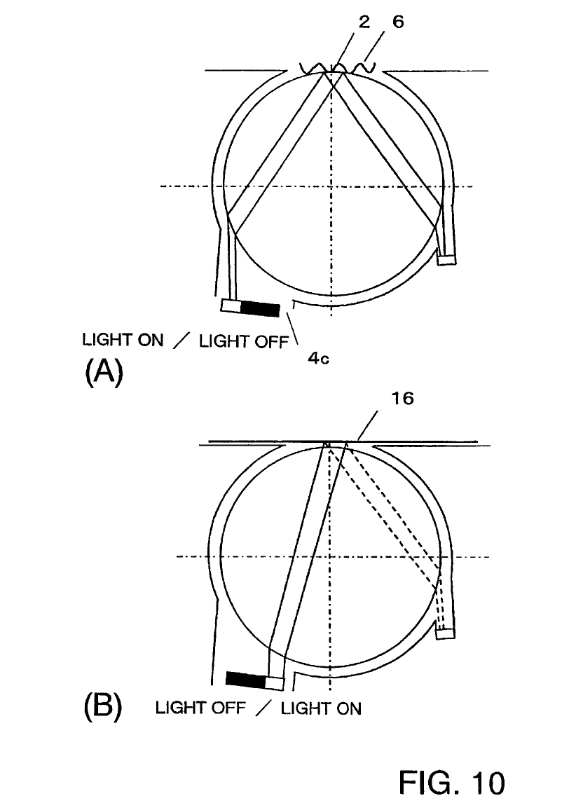

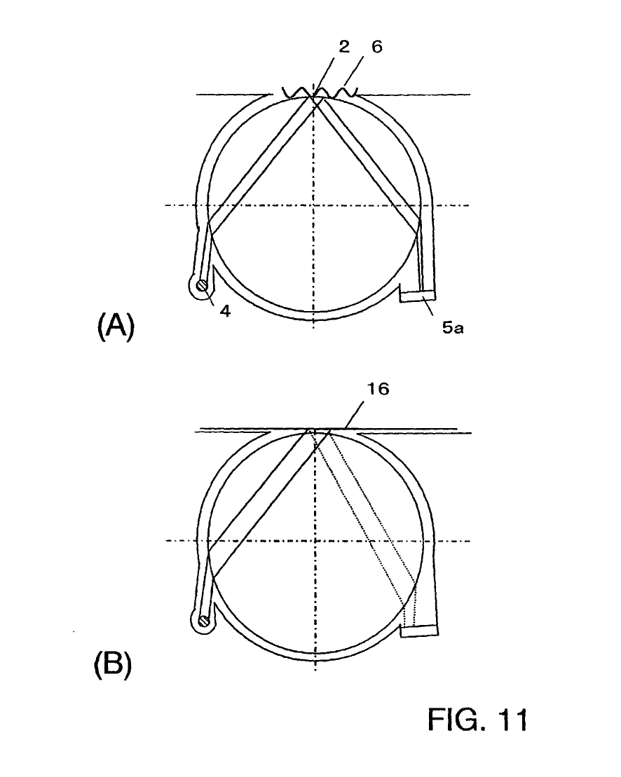

FIG. 9 shows an image reading apparatus having two light sources. FIG. 10 shows an image reading apparatus having a planar light source capable of switching the light emission area like an EL. FIG. 11 shows an image reading apparatus having a light detecting means with a large light reception area.

In the image reading apparatuses shown in FIGS. 9 and 10, in the cases of FIGS. 9A and 10A, the light source is set in a first output mode in which the incident angle is not smaller than 20 degrees and not larger than the critical angle and in which the illuminance is of a value not less than a fixed value. Thus, mainly the reflected light is detected. On the other hand, in the cases of FIGS. 9B and 10B, the light source is set in a second output mode in which the incident angle is not larger than 20 degrees and in which the illuminace is of a value not less than a fixed value. Thus, mainly the scattered light is detected. By appropriately switching the output mode of the light source in operating the apparatus, it is possible to read a fingerprint in the first output mode, and to read a planar image like an original in the second output mode.

In the image reading apparatus shown in FIG. 11, the light source is set such that the incident light is in the range not larger than the critical angle and not smaller than 20 degrees and that the illuminance is of a value not less than a fixed value. The apparatus has a first light reception region shown in FIG. 11A for mainly receiving reflected light, and a second light reception region shown in FIG. 11B for mainly receiving scattered light. By setting the light detecting means 5a such that a fingerprint is read by the first light reception region and that a paper sheet or the like is read by the second light reception region, it is possible to read the images of both a fingerprint and an original.

While the image reading apparatus shown in FIG. 11 uses a single light detecting means, the reading of both a fingerprint and an original is possible if a plurality of light detecting means, for example, a light detecting means for reflected light and a light detecting means for scattered light, are used.

Next, other embodiments of the present invention will be described.

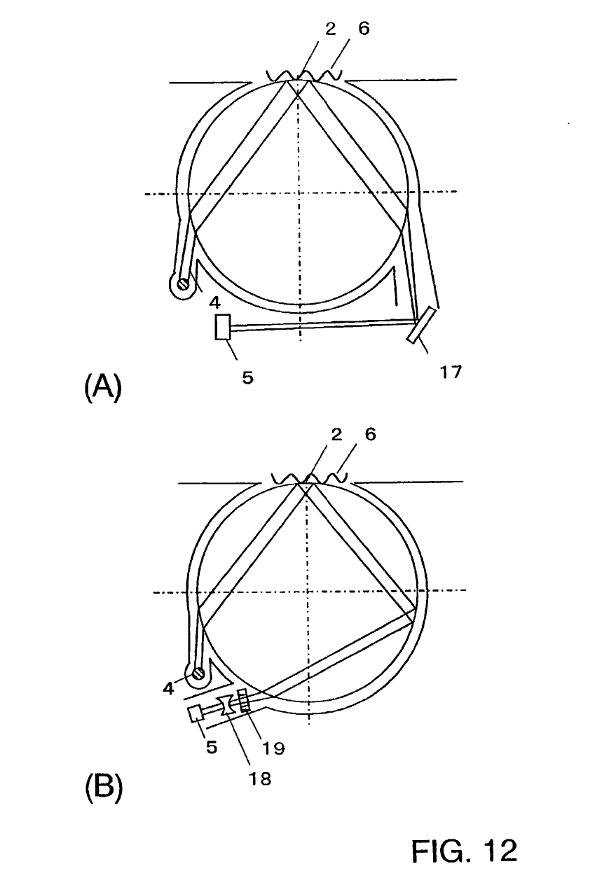

In the embodiment shown in FIG. 12, there is provided between the first rotary member 3 and the light detecting means 5 an image formation optical system composed of a mirror 17, an optical lens 18, and a field stop 19, whereby it is possible to correct image distortion and to achieve a reduction in the size of the light detecting means and the entire apparatus. While in the image reading apparatus shown in FIG. 12 an equivalence optical system is used with respect to the axial direction of the rotary member, the present invention is also applicable to an image reading apparatus using a reduction optical system with respect to the axial direction of the rotary member.

In the embodiment shown in FIG. 13, there is provided between the first rotary member 3 and the light detecting means 5 an optical fiber bundle 20, whereby it is possible to eliminate the influence of scattered light impinging upon the bundle of optical fibers at a large incidence angle, and it is possible to increase the degree of freedom with respect to the optical path, thereby achieving a reduction in the size of the entire apparatus.

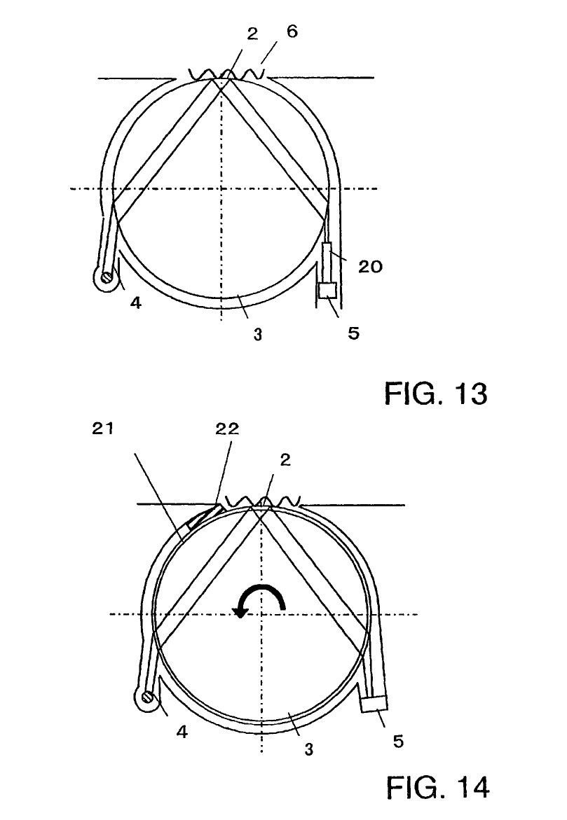

In the embodiment shown in FIG. 14, the surface of the rotary member is coated with a dirt prevention layer 21, and there is provided between the casing 1 and the rotary member 2 a cleaner 22 for removing dust such as waste thread or dirt such as grease adhering to the input surface of the rotary member, whereby factors constituting an obstacle to image reading are removed, making it possible to maintain the requisite accuracy in image reading.

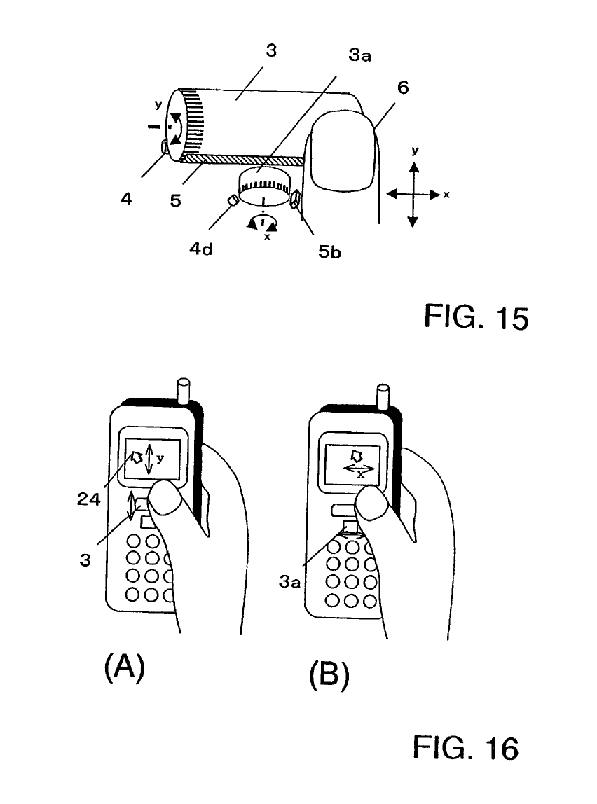

FIG. 15 shows a variation of the image reading apparatus of the present invention in which there are further provided a second rotary member 3a and a second rotating amount detecting means, thereby providing a two-dimensional position input function.

Numeral 3 indicates a first rotary member adapted to rotate as the finger is moved, numeral 4 indicates a first light source, and numeral 5 indicates a first light detecting means for detecting light reflected by a light-dark pattern formed on the surface of the first rotary member. The light detecting means converts an optical signal to an electric signal, and a signal processing means detects a rotating amount, whereby it is possible to effect a one-dimensional position output in accordance with the rotating amount of the finger or the first rotary member.

Similarly, due to the addition of a second light source 4d and a second light detecting means 5b, it is also possible to detect the rotating amount of the second rotary member 3a, whereby it is possible to effect a two-dimensional position output in accordance with the rotating amount of the finger 6 or the first rotating member and that of the second rotating member.

While the construction shown in FIG. 15 adopts the second light source and the second light detecting means adapted to optically detect patterns to detect the rotating amount of the second rotary member, any means will do as long as it is capable of detecting rotating amount. For example, it is also possible to use a rotary encoder for mechanically detecting the rotating amount of the second rotary member. Further, it is possible to realize an image reading apparatus provided with a one-dimensional position input function by using the first rotary member, first light source, and first light detecting means, without using the second rotary member, second light source, and second light detecting means.

FIG. 16 shows a mobile phone containing an image reading apparatus according to the present invention. An image reading apparatus as shown in FIG. 15 is mounted in the mobile phone, and further a software package needed for the identification of a fingerprint, etc. are mounted, whereby it is possible to realize an apparatus which is compact and inexpensive and provided with a fingerprint identifying function, cursor input function, etc.

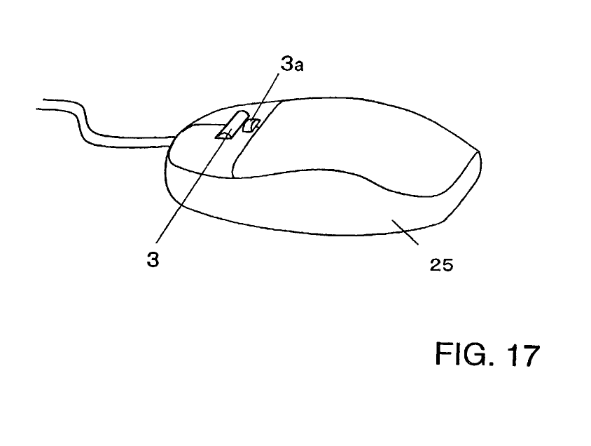

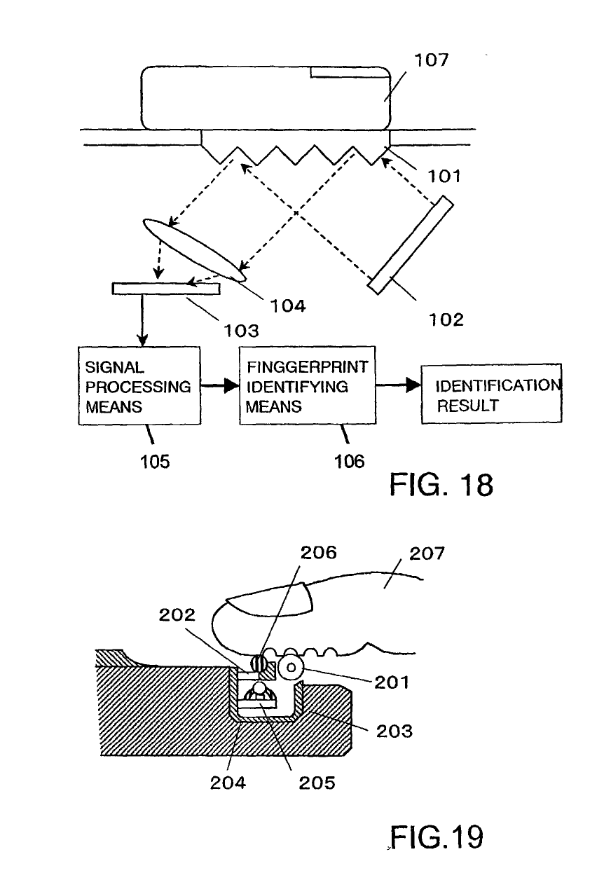

FIG. 17 shows a mouse in which an image reading apparatus as shown in FIG. 16 is mounted. An image reading apparatus according to the present invention is mounted in a mouse, and, further, a software package, etc. needed for fingerprint identification are mounted in a computer main body (not shown) to which the mouse is connected, whereby it is possible to realize an apparatus which is compact, inexpensive, and provided with a fingerprint identifying function and a scroll function.

As described above, in accordance with the present invention, there is provided an image reading apparatus including a light source, a rotary member having an input surface, and a light detecting means, and adapted to detect light from the input surface, wherein reflected light from the input surface is detected by the light detecting means as a partial image, and wherein the rotating amount of the rotary member, which rotates while in contact with the object of reading, is detected by the light detecting means in order to calculate the relative moving amount of the object of reading and the image reading apparatus, a two-dimensional whole image being synthesized from the partial image. Thus, it is possible to omit a rotary encoder for detecting finger moving amount, a processor for calculating relative moving speed from fingerprint pattern, etc., which have been necessary for the recognition of a fingerprint or the like, and to reduce the size of the light detecting means, whereby it is possible to achieve a substantial reduction in the total cost of an image reading apparatus. Further, by detecting not only reflected light from the input surface but also scattered light, it is possible to realize a simple and small image reading apparatus capable of reading both an object of reading having protrusions and recesses like a fingerprint and a planar object of reading having light and shade like an original.

Further, by providing, in addition to the image reading function, an input function utilizing the rotary member as an encoder, it is possible to realize a compact and inexpensive input apparatus such as a mobile phone or a mouse provided with both an image reading function for reading a fingerprint or the like and an input function.

### INDUSTRIAL APPLICABILITY

As described above, the image reading apparatus of the present invention is useful as a fingerprint detecting apparatus and as an apparatus for reading a planar object of reading having light and shade like an original.

1. An image reading apparatus comprising a light source, an input member having an input surface for an object of reading, and a light detecting means composed of a plurality of photoelectric conversion elements for detecting light scattered or reflected at an interface between the object of reading and the input surface,
wherein the input member is made from a transparent base member and is constructed of a rotary member rotating in accordance with an amount of relative movement between the object of reading and the image reading apparatus,
the apparatus further comprising a whole image synthesizing means which detects a rotating amount of a first rotary member by a first light detecting means to detect an amount of relative movement between the object of reading and the image reading apparatus and which obtains a whole image of the object of reading on the basis of a partial image obtained by the first light detecting means and the movement amount.

2. An image reading apparatus according to claim 1, wherein a light-dark pattern is formed on a surface at one end of the first rotary member, and wherein the first light detecting means detects light emitted from a first light source and transmitted through the light-dark pattern to thereby detect a rotating amount of the first rotary member.

3. An image reading apparatus according to claim 1 or 2, characterized in that the first light detecting means is at a position where it receives reflected light generated from the interface between the object of reading and the input surface and determined by Snell's law.

4. An image reading apparatus according to claim 1 or 2, characterized in that the first light detecting means is at a position where it receives reflected light generated from the interface between the object of reading and the input surface and determined by Snell's law and scattered light generated from the interface between the input surface of the first rotary member and the object of reading.

5. An image reading apparatus according to claims 1 through 4, characterized in that incident light emitted from the first light source and incident on the input surface has a plurality of different incidence angle components.

6. An image reading apparatus according to any of claims 1 through 5, characterized in that the image reading apparatus has one of an image formation optical system and a mirror between optical paths of the first rotary member and the first light detecting means.

7. An image reading apparatus according to any of claims 1 through 6, characterized in that the image reading apparatus has an optical fiber bundle between the optical paths of the first rotary member and the first light detecting means.

8. An image reading apparatus according to any of claims 1 through 7, characterized in that the first rotary member is formed of a glass base material which is an inorganic base material or a synthetic resin which is an organic base material.

9. An image reading apparatus according to any of claims 1 through 8, characterized in that the image reading apparatus has, on the input surface of the first rotary member, a dirt prevention layer adapted to prevent dirt from adhering to the surface.

10. An image reading apparatus according to any of claims 1 through 9, characterized in that the image apparatus has a cleaner adapted to remove dirt adhering to the surface of the first rotary member.

11. An image reading apparatus according to any of claims 1 through 10, characterized in that the object of reading includes an object of reading having protrusions and recesses like a fingerprint and an object of reading having light and shade like an original.

12. An image reading apparatus according to any of claims 1 through 11, characterized in that the image reading apparatus has a function by which a one-dimensional position input is effected in accordance with the rotating amount of the first rotary member.

13. An image reading apparatus according to any of claims 1 through 11, further comprising a second rotary member having a rotation axis different from the rotation axis of the first rotary member and a means for detecting a rotating amount of the second rotary member, wherein there is provided a function by which a two-dimensional position input is effected in accordance with the rotating amount of the first rotary member and that of the second rotary member.

14. An image reading apparatus according to any of claims 1 through 11, further comprising a second rotary member which has a rotation axis different from the rotation axis of the first rotary member and on the surface of one end portion of which a light-dark pattern is formed, a second light source, a second light detecting means, and a rotating amount detecting means for detecting a rotating amount of the second rotary member by detecting light emitted from the second light source and transmitted through the light-dark pattern formed on the surface of the second rotary member, wherein there is provided a function by which a two-dimensional position input is effected in accordance with the rotating amount of the first rotary member and that of the second rotary member.
